(19) United States
(12) Patent Application Publication
(10) Pub. No.: US 2018/0187774 A1
(43) Pub. Date: Jul. 5, 2018

(54) Method For Vehicle Control During Off-Road Operation Using A Ball Planetary Type Continuously Variable Transmission

(71) Applicant: Dana Limited, Maumee, OH (US)

(72) Inventors: T. Neil McLemore, Georgetown, TX (US); Travis J. Miller, Cedar Park, TX (US); Sebastian J. Peters, Cedar Park, TX (US)

(21) Appl. No.: 15/848,631

(22) Filed: Dec. 20, 2017

Related U.S. Application Data
(60) Provisional application No. 62/441,744, filed on Jan. 3, 2017.

(51) Int. Cl. F16H 59/44; B60W 10/108; B60W 30/182; F16H 61/664; F16H 15/50

(52) U.S. Cl. CPC F16H 59/44; B60W 10/108; F16H 2059/0221; F16H 61/6646; F16H 15/503; B60W 30/182

(57) ABSTRACT

Provided herein is a method and a control system for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The transmission control module includes a CVP control module. In some embodiments, the transmission control module is configured to implement an off-road control process. The off-road control process receives a number of input signals indicative a driver's desired vehicle speed, and issues commands to adjust the variator to maintain the desired vehicle speed.

### RELATED APPLICATION

The present application claims the benefit of U.S. Provisional Application No. 62/441,744 filed on Jan. 3, 2017, which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations can for example, multiply input torque across the different transmission stages in different manners to achieve the same final drive ratio. However, some configurations provide more flexibility or better efficiency than other configurations providing the same final drive ratio.

Many modern vehicles are used for recreational purposes such as rock crawling, or other off-road activities. In vehicles used for off-roading (rock crawling, mudding, etc.) it is often desirable to travel at very low vehicle speeds while providing as much torque as possible to the vehicle wheels. For vehicles equipped with typical manual transmissions, low speed operation is achieved by the driver controlling the throttle or accelerator pedal input and slipping the clutch manually with the clutch pedal. For vehicles equipped with automatic transmissions, the driver is limited during low speed operation by the torque converter.

### SUMMARY

The preferred embodiments disclosed herein are related to transmissions having a variable ratio that allow the driver to maintain a higher engine speed, to thereby keep the engine high on its torque curve, while moving the vehicle at a very slow and stable speed. The control method described herein is useful when the first gear ratio is very low and the launch ratio of the variable portion of the transmission is near 1:1. In this case, a ratio “reserve” exists in first gear. By using a variable ratio device such as a ball-type continuously variable transmission (CVP) to control the transmission output torque and ultimately the wheel torque, the engine operates at its optimal power and fuel efficient point, independent of wheel speed and torque.

Provided herein is a method for controlling a continuously variable transmission having a ball-planetary variator (CVP) provided with a ball in contact with a first traction ring assembly, a second traction ring assembly, and an idler assembly, wherein the continuously variable transmission is operably coupled to an engine, the method including the steps of: receiving a plurality of input signals indicative of a vehicle speed, an engine speed, and an operator's input; evaluating an off-road condition based on the operator's input; determining a vehicle speed setpoint based on the vehicle speed and the operator's input; determining a CVP ratio setpoint based on the engine speed and the vehicle speed setpoint; and issuing a commanded CVP ratio to impart a change in the operating condition of the CVP.

Provided herein is a gear shifter for a vehicle having a continuously variable transmission, the gear shifter including a handle grip accessible by a user on an interior of the vehicle and a rotary knob sensor coupled to the handle grip. The rotary knob sensor is configured to provide an indication of a desired vehicle speed setpoint.

Provided herein is a vehicle including a continuously variable planetary having a first traction ring assembly and a second traction ring assembly in contact with a plurality of balls, wherein each ball of the plurality of balls has a tiltable axis of rotation and wherein the ball variator assembly is coaxial with the main axis; and a controller configured to control the vehicle during off-road operation based on a plurality of input signals including a vehicle speed signal, an engine speed signal, and an operator's input signal. The controller is configured to determine a vehicle speed setpoint. The controller issues a commanded CVP speed ratio based at least in part on the vehicle speed setpoint.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system implementable in a vehicle.

FIG. 5 is a flow chart depicting a vehicle control process that is implementable in the vehicle control system of FIG. 4.

FIG. 6 is an isometric view of a gear position handle equipped with an off-road speed control knob.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, accelerator pedal position sensor values, vehicle speed, gear selector position, user-selectable mode configurations, and the like, or some combination thereof. The electronic controller can also receive one or more control inputs. The electronic controller can determine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. Patent Application No. 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

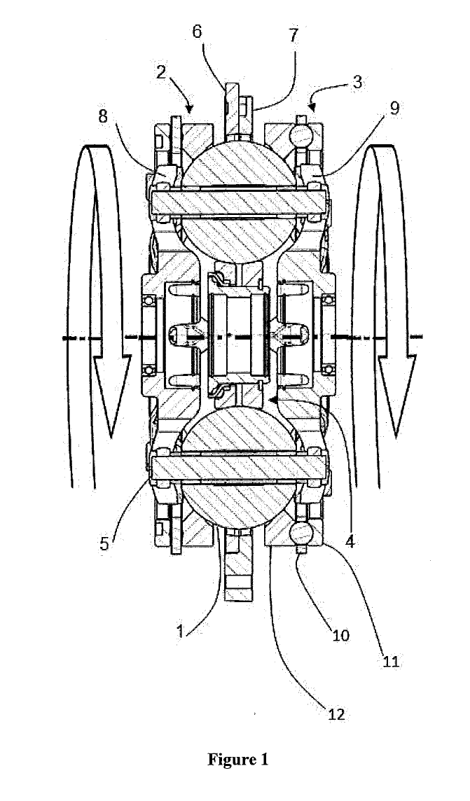

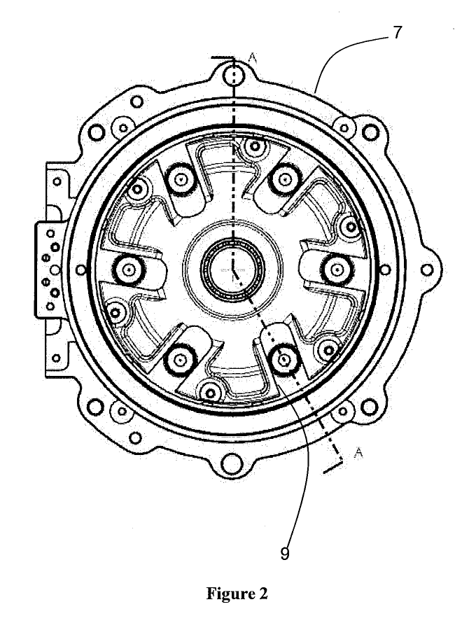

Provided herein are configurations of CVTs based on a ball-type variator, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input traction ring assembly 2 and output traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

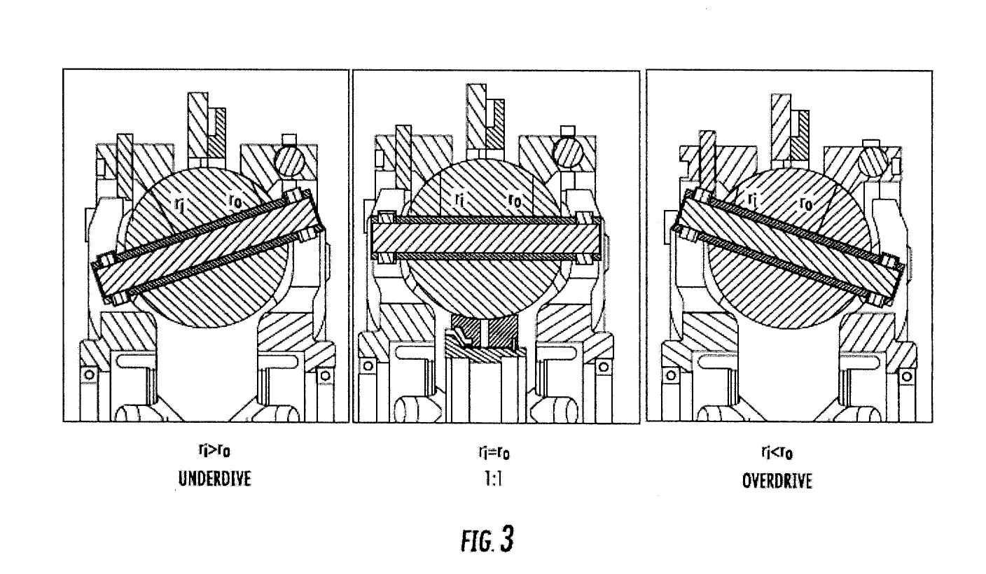

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction.” Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here can operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, can be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present embodiments. For example, various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Software associated with such modules can reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium can be integral to the processor. The processor and the storage medium can reside in an ASIC. For example, in one embodiment, a controller for use of control of the CVT includes a processor (not shown).

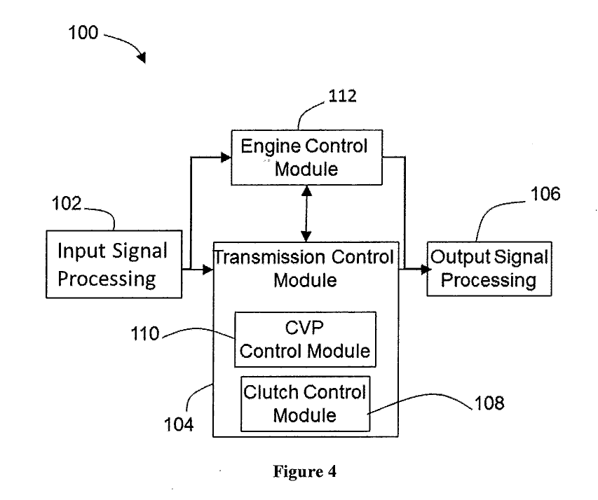

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle, transmission, and/or other control modules. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors as well as other control modules. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104. In some embodiments, the engine control module 112 is optionally configured to have a dedicated input signal processing module and output signal processing module.

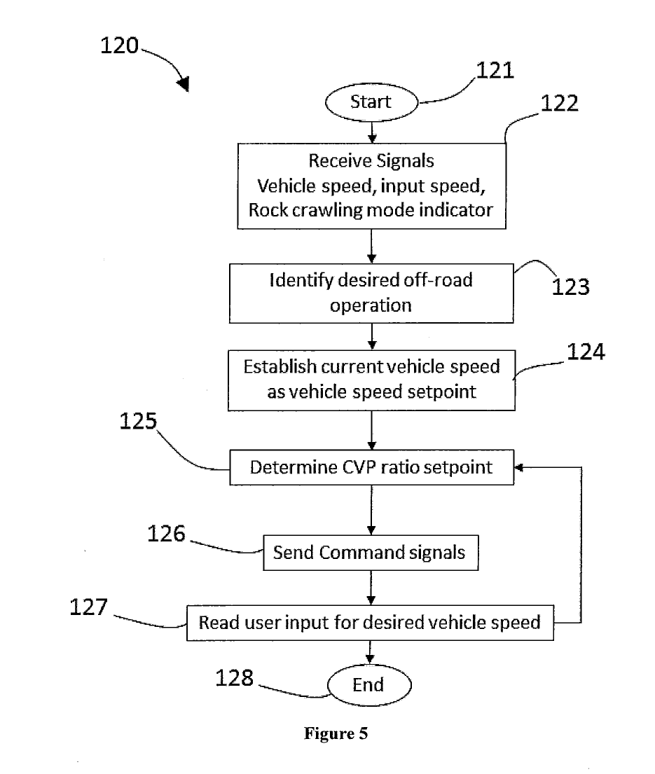

Referring now to FIG. 5, in some embodiments, the transmission control module 104 is configured to implement an off-road control process 120. The off-road control process 120 begins at a start state 121 and proceeds to a block 122 where a number of input signals are received. For example, the input signals are provided by the input signal processing module 102 and include a vehicle speed, an engine speed, and a wheel speed, among others. In some embodiments, the block 122 receives a signal indicative of a user's input to set a desired vehicle speed. Typically, for off-road operation, the desired vehicle speed is low, for example in the range of zero to 5 miles per hour. In some embodiments, the user's input means is a rotary knob attached to the gear shift lever, paddles located on the steering wheel, or a brake pedal position sensor. The off-road control process 120 proceeds to a block 123 where a driver's desire for off-road operation is identified. In some embodiments, identification of off-road operation is performed by accessing the user's input from a button or switch. It should be appreciated that the block 122 and the block 123 are optionally configured as initialization steps in the off-road control process 120. The off-road control process 120 proceeds to a block 124 where a current vehicle speed is measured and set as the vehicle speed set point. In some embodiments, the off-road control process 120 is entered when the vehicle is at a non-zero speed. In such cases, the current vehicle speed is set as the target speed to maintain. In some embodiments, the off-road control process 120 is optionally provided with a step of raising the engine speed setpoint. For example, the engine control module 112 is optionally configured to include tables or maps of the engine torque and efficiency based on engine speed. In some embodiments, the off-road control process 120 is optionally configured to send command signals to the engine control module 112 to operate the engine at a high torque, high efficiency setpoint. In some embodiments, the off-road control process 120 is configured to provide an elevated engine speed command to the engine control module 112. The off-road control process 120 proceeds to a block 125 where a CVP ratio setpoint is determined. For initial operation, determining the CVP ratio setpoint is a computation based on the current vehicle speed and a current transmission input speed. The off-road control process 120 proceeds to a block 126 where the CVP ratio setpoint is sent as a command signal to a CVP actuator. The off-road control process 120 is adapted to proceeds a block 127 where a user's input is evaluated to determine a desired vehicle speed. The off-road control process 120 returns to the block 125. In some embodiments, the off-road control process 120 proceeds to an end state 128.

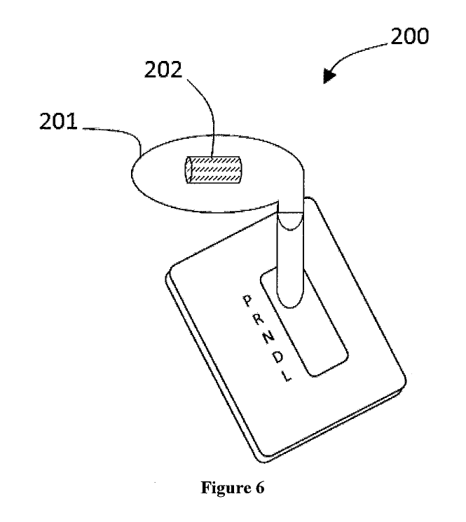

Turning now to FIG. 6, in some embodiments, a gear shifter 200 is provided with a handle 201. Typically, the gear shifter 200 is located within an operator's reach inside of the vehicle and is used to communicate the operator's desired vehicle operation, such as, a “park” mode, a “reverse” mode, a “neutral” mode, a “drive” mode, and a “low” mode. In some embodiments, the handle 201 is provided with a rotary knob 202. The rotary knob 202 is an electric sensor configured to receive input from the operator during certain modes of operation, such as an off-road mode of operation. In some embodiments, an off-road enable button (not shown) is provided on the interior of the vehicle within the operator's reach. Once an off-road operating condition is signaled by the user, the rotary knob 202 provides a means to adjust a target vehicle speed. In some embodiments, off-road operation is signaled by the user by adjusting the gear shifter 200 to a low gear. In some embodiments, the gear shifter 200 is optionally configured to have an off-road position.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein can be employed in practicing the preferred embodiments. It is intended that the following claims define the scope of the preferred embodiments and that methods and structures within the scope of these claims and their equivalents be covered thereby.

What is claimed is:

1. A method for controlling a continuously variable transmission having a ball-planetary variator (CVP) provided with a ball in contact with a first traction ring assembly, a second traction ring assembly, and an idler assembly, wherein the continuously variable transmission is operably coupled to an engine, the method comprising the steps of:
receiving a plurality of input signals indicative of a vehicle speed, an engine speed, and an operator's input;
evaluating an off-road condition based on the operator's input;
determining a vehicle speed setpoint based on the vehicle speed and the operator's input;
determining a CVP ratio setpoint based on the engine speed and the vehicle speed setpoint; and
issuing a commanded CVP ratio to impart a change in the operating condition of the CVP.

2. The method of claim 1, wherein evaluating an off-road condition further comprises receiving a signal from a rotary knob indicative of an operator's desired vehicle speed.

3. The method of claim 1, wherein evaluating an off-road condition further comprises receiving a signal from a gear shifter and a brake pedal position sensor.

4. The method of claim 1, wherein determining a CVP ratio setpoint further comprises adjusting an engine speed command signal.

5. The method of claim 4, wherein adjusting an engine speed command signal further comprises determining a target engine operating condition based on a calibrated efficiency table.

6. A gear shifter for a vehicle having a continuously variable transmission, the gear shifter comprising:
a handle grip accessible by a user on an interior of the vehicle; and
a rotary knob sensor coupled to the handle grip, the rotary knob sensor configured to provide an indication of a desired vehicle speed setpoint.

7. The gear shifter of claim 6, further comprising a plurality of selectable gear positions.

8. The gear shifter of claim 6, further comprising a button configured to indicate an off-road mode of operation.

9. The gear shifter of claim 6, wherein the rotary knob sensor is a potentiometer.

10. The gear shift of claim 6, wherein the rotary knob sensor is accessible to a user's hand on the interior of the vehicle.

11. A vehicle comprising:
a continuously variable planetary (CVP) having a first traction ring assembly and a second traction ring assembly in contact with a plurality of balls, wherein each ball of the plurality of balls has a tiltable axis of rotation and wherein the ball variator assembly is coaxial with a main axis; and
a controller configured to control the vehicle during off-road operation based on a plurality of input signals comprising:
a vehicle speed signal;
an engine speed signal; and
an operator's input signal;
wherein the controller is configured to determine a vehicle speed setpoint; and
wherein the controller issues a commanded CVP speed ratio based at least in part on the vehicle speed setpoint.

12. The vehicle of claim 11, wherein the vehicle speed setpoint is based on the vehicle speed signal and the operator's input signal.

13. The vehicle of claim 12, wherein the commanded CVP speed ratio is further based on the engine speed signal.

14. The vehicle of claim 13, wherein the controller is configured to identify the off-road operation based at least in part on the operator's input signal.

15. The vehicle of claim 14, further comprising a button adapted to indicate the operator's input signal.

16. The vehicle of claim 14, further comprising a rotary knob adapted to indicate the operator's input signal.

17. The vehicle of claim 15, wherein the button is located on the interior of the vehicle within a driver's reach.

18. The vehicle of claim 16, wherein the rotary knob is located on a gear shift lever on the interior of the vehicle.
